(19) United States
(12) Patent Application Publication
(10) Pub. No.: US 2015/0136662 A1
(43) Pub. Date: May 21, 2015

(54) METHOD AND SYSTEM FOR RECOVERING RECYCLABLE MATERIALS FROM AN ASR LANDFILL

(71) Applicant: Thomas Valerio, Atlanta, GA (US)

(72) Inventor: Thomas Valerio, Atlanta, GA (US)

(21) Appl. No.: 14/510,842

(22) Filed: Oct. 9, 2014

Related U.S. Application Data
(60) Provisional application No. 61/888,691, filed on Oct. 9, 2013.

(51) Int. Cl. B07B 15/00

(52) U.S. Cl. CPC B07B 15/00
USPC 209/3; 209/12.1

(57) ABSTRACT

Processing excavated ASR from an ASR landfill. The processing includes excavating the ASR and co-mingled material, sizing the excavated material, separating the excavated, sized material into a heavy and light fraction, and further processing the heavy fraction to recover ferrous and non-ferrous metals.

### CROSS-REFERENCE TO RELATED APPLICATIONS

The present application claims priority under 35 U.S.C. Section 119(e) to U.S. Provisional Patent Application No. 61/888,691, filed Oct. 9, 2013, and titled “Method And System For Recovering Recyclable Materials From An ASR Landfill,” the entire content of which is incorporated herein by reference.

### FIELD OF THE INVENTION

This invention relates to systems and methods for recovering recycled materials from a landfill that contains automobile shredder residue (ASR). More particularly, this invention relates to systems and methods for recovering ferrous and non-ferrous metals from automobile shredder residue (ASR) and other shredder residue by mining an ASR landfill and recovering the materials.

### BACKGROUND OF THE INVENTION

Recycling waste materials is highly desirable from many viewpoints, not the least of which are financial and ecological. Properly sorted recyclable materials can often be sold for significant revenue. Many of the more valuable recyclable materials do not biodegrade within a short period, and so their recycling significantly reduces the strain on local landfills and ultimately the environment.

Typically, waste streams are composed of a variety of types of waste materials. One such waste stream is generated from the recovery and recycling of automobiles or other large machinery and appliances characterized by the fact that a majority of the material (typically over 65%) is made of ferrous metal. For examples, at the end of its useful life, an automobile is shredded. This shredded material is processed by one or more large drum magnets or the like to recover most of the ferrous metal contained in the shredded material. The remaining materials, referred to as automobile shredder residue, or ASR, may still include ferrous and non-ferrous metals, including copper wire and other recyclable materials. ASR is mainly made up of non-metallic material (dirt, dust, plastic, rubber, wood, foam, et cetera), non-ferrous metals (mainly aluminum but also brass, zinc, stainless steel, lead, and copper) and some remaining ferrous metal that was not recovered by the first main ferrous recovery process (that is, the drum magnets).

The ASR resulting from the recovery of much of the ferrous metal in the waste stream is referred to as “virgin” ASR. Virgin ASR typically contains less than 15 percent metals. L. Fabrizi et al. provides a characterization of typical virgin ASR. ASR includes 23 percent elastomers; 13 percent glass and ceramics; 13 percent chlorine free thermosets and form parts; 13 percent iron; 7 percent foam material; 6 percent polyvinyl chloride (PVC); 6 percent other fibers and cover-materials; 5 percent other components; 4 percent wood, paper, and cardboard; 3 percent aluminum; 3 percent other thermosets; 3 percent paint; and 1 percent copper. See L. Fabrizi et al., Wire Separation from Automobile Shredder Residue, Physical Separation in Science and Engineering, Vol. 12, No. 3, pp. 145-165 (2003). In addition to the diversity of the nature of the materials in ASR, the materials are present in ASR in different shapes and sizes. The large differences in sizes is explained by the size of the shredders used in the ASR industry and explained by the size of the rack pieces (cars, trucks, etc.) that enter the shredders, which is unique to ASR as compared to other waste materials. The diversity of material shapes is explained in part by the varying nature of the material.

Although the Fabrizi et al. data shows that ASR includes certain materials that could be recycled, past practice was typically to dispose of ASR as waste. Often this waste was disposed of in dedicated ASR landfills—landfills that were used exclusively, or at least primarily, for ASR waste. Metals such as lead, cadmium, mercury, copper, nickel, zinc, arsenic, and chromium are all present in ASR and all pose a risk to the environment. Polychlorinated biphenyl (PCBs) and total petroleum hydrocarbons (TPH) as well as lower levels of volatile organic compounds (VOCs) and semi-volatile organic compounds (SVOCs) found in ASR also pose an environmental risk. As a result, these landfills presently pose an environmental hazard. Indeed, ASR landfill are generally classified as hazardous waste facilities. These facilities incur continuous monitoring and protection expenses by their operators while at all times posing a risk to the surrounding environment. If certain metals could be reclaimed from these landfills, negative impacts from these waste facilities on the environment can be mitigated.

Once disposed in landfill, the ASR waste gets blended with soil or other non-ASR materials used as cover, which dilutes the concentration of the residual metals in the waste steam as compared to their concentrations in virgin ASR. The profitability of the technologies and processes used for recovering metals from virgin ASR depends on the concentration of metals present in ASR. The higher the metal content, the higher the profitability. Once disposed in landfill, the concentration of the residual metals further decreases while the difficulty for further recovering those metals increases. Also, once disposed in a landfill, the ASR waste is compacted as a result of the weight of the multiple layers of waste piled up in the landfill (typically ASR landfill are over 30′ deep). Further processing the ASR waste requires the material to be removed from the ground and isolated.

Accordingly, a need exists for cost-effective, efficient methods and systems for recovering metals from ASR landfills.

### SUMMARY OF THE INVENTION

The present invention provides cost-effective, efficient methods and systems for recovering metals from material excavated from ASR landfills, thus reducing the adverse environmental impact of these recyclable metals on the environment.

One aspect of the present invention provides a method for recovering metal from material excavated from an automobile shredder residue (ASR) landfill. The method includes the steps of: (1) excavating a landfill comprising ASR material; (2) screening the excavated ASR material to generate a sized ASR material fraction; (3) separating the sized ASR material fraction into a heavy fraction and a light fraction, where the heavy fraction includes ferrous and non-ferrous metals; and (4) processing the heavy fraction to recover the ferrous and non-ferrous metals.

Another aspect of the present invention provides a system for recovering metal from material excavated from an ASR landfill. The system includes a source of ASR material comprising material excavated from an ASR landfill; a screen for screening the excavated ASR material to generate a sized ASR material fraction; a separator for separating the sized ASR material fraction into a heavy fraction and a light fraction; and a recovery subsystem for processing the heavy fraction of the sized ASR fraction to recover ferrous and non-ferrous metals.

### BRIEF DESCRIPTION OF THE DRAWINGS

FIG. 1 depicts a schematic diagram for a system to recover recyclable metals from an ASR landfill to in accordance with an exemplary embodiment of the present invention.

FIG. 2 depicts a schematic diagram of a separator for ASR landfill materials in accordance with an exemplary embodiment of the present invention.

FIG. 3 depicts a process flow diagram for a process for processing material excavated from an ASR landfill to recover recyclable metals in accordance with an exemplary embodiment of the present invention.

### DETAILED DESCRIPTION OF THE EXEMPLARY EMBODIMENTS

Exemplary embodiments of the present invention provide systems and methods for recovering recyclable material such as ferrous and non-ferrous metals from material excavated from ASR landfills.

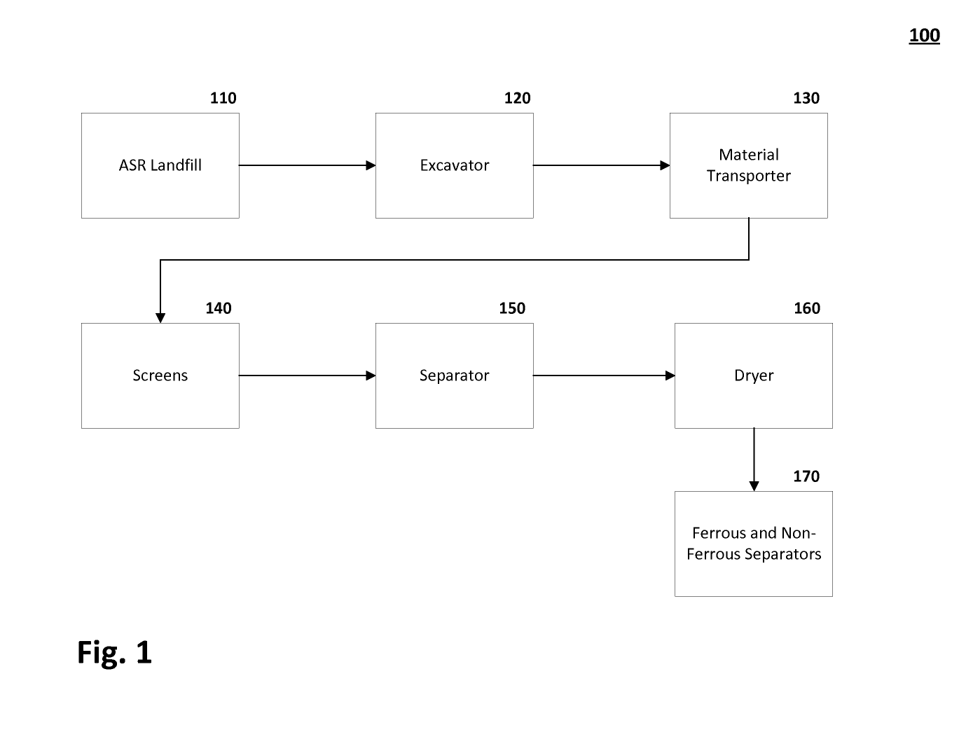

FIG. 1 depicts a schematic diagram for a system 100 to recover recyclable metals from an ASR landfill in accordance with an exemplary embodiment of the present invention. Referring to FIG. 1, an ASR landfill 110 includes buried ASR waste. Typically, an ASR landfill would include excavated areas of earth. ASR is added to the excavated area. Often, the ASR is mixed with soil or other fill material and placed in the excavation in layers. The excavated area is topped with a cap that minimizes the infiltration of water into the excavated region and may also include other features, such as erosion control. Alternatively, the ASR may be mounded in layers, with each layer covered with soil or other fill. Once the mounded reaches a designated height, the mound is capped to prevent erosion and water infiltration. The layering and covering process also includes a compaction step. The amount of ASR exposed to air is minimized to prevent any combustion of the material. Monitoring operations are also typically conducted in and around the landfill areas.

To reclaim certain ASR materials, such as ferrous and non-ferrous metals, the ASR must be removed from the landfill. An excavator 120 excavates the ASR landfill material. The excavated material includes both the ASR and soil and other fill used in the original landfilling process—that is, ASR and co-mingled material (“ASR material”). The excavator 120 moves the excavated ASR material into a material transporter 130. In one embodiment, the material transporter 130 is a bulk material transport vehicle, such as a dump truck. Alternative embodiments may include other material transporters 130, such as a rail car or cargo container. In yet another alternative embodiment, the ASR material may be processed at the excavation site. In this embodiment, the material transporter 130 is a material conveyor, such as a system of conveyor belts and/or augers. The material transporter 130 may be a combination of components, such as a dump truck that moves the material from the excavation site to another transporter, such as a rail car or a conveyor system.

One or more screens 140 are employed to segregate the excavated ASR material by size. The one or more screens 140 process the excavated ASR material so as to generate a feed material for a separator 150 that typically ranges in size from 1 mm to 150 mm, although a broader size range is possible. Excavated ASR material that is less than 1 mm in size most likely does not include any ferrous or non-ferrous metals worth recovering, as material of this size is most likely soil or other fill material. This material is disposed of as waste. ASR material that is greater than 150 mm in size may be further processed by size-reducing equipment (not shown) and re-introduced into the screens 140 or into the separator 150.

In an alternative embodiment, the one or more screens 140 may segregate the excavated ASR material into more discrete size ranges, such as from 1 mm to 5 mm, 5 mm to 20 mm, 20 mm to 50 mm, and 50 mm to 150 mm, based on the mesh size of the screens. Material falling within these four size ranges are separately introduced into the separator 150. By introducing segregated material into the separator 150 at these more discrete size ranges, rather than an aggregate of the material that ranges in size from 1 mm to 150 mm, the overall efficiency in the separation 150 is improved.

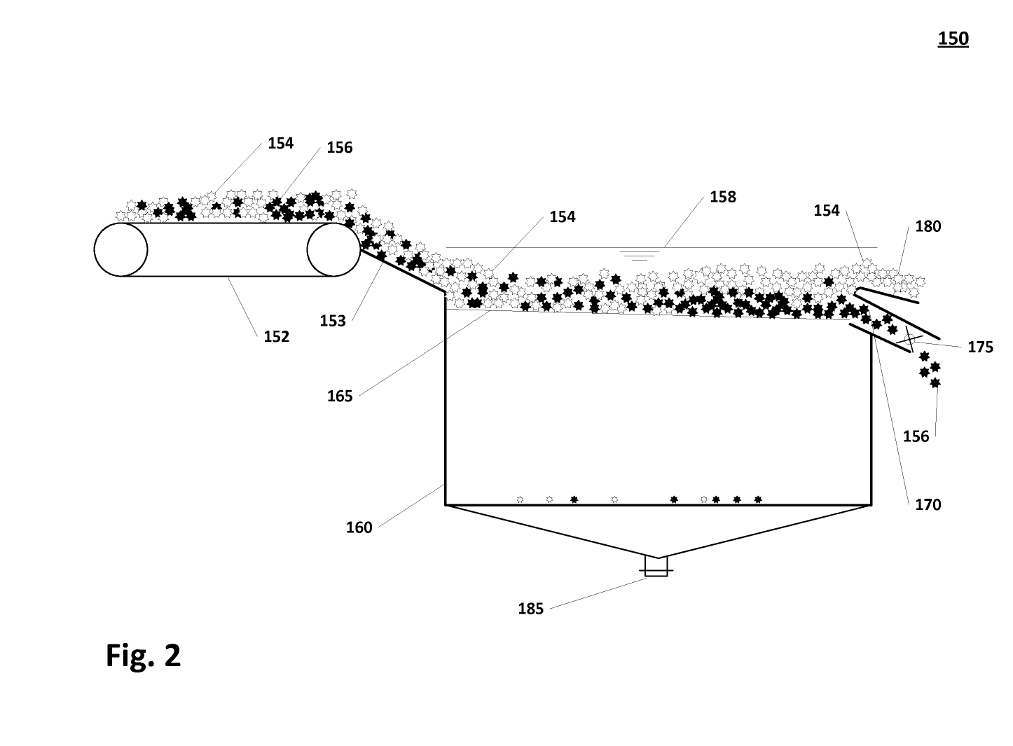

The separator 150 separates the screened excavated ASR material into a heavy fraction and a light fraction. The heavy fraction includes metals, rocks, and glass, including the non-ferrous and ferrous metals to be recovered. Typically, the heavy fraction will be about 20 percent of the overall volume of processed material, which concentrates the metal to be recovered by a factor of 5 over its concentration in the ASR landfill. The operation of an exemplary separator 150 is discussed in greater detail below, in connection with FIG. 2.

As will be discussed in greater detail below in connection with FIG. 2, the separator 150 employs a liquid, such as water, to separate the excavated ASR material into a heavy fraction and a light fraction. Before further processing, the heavy fraction from the separator 150 is dried, such as in a dryer 160. In an alternative embodiment, the dryer 160 is omitted and the heavy fraction material is allowed to air dry. Typically, the heavy fraction should have less than 15 percent moisture prior to further processing to recover ferrous and non-ferrous metals.

The heavy fraction is further processed in a ferrous and non-ferrous metal recovery subsystem 170 to recover ferrous and non-ferrous metals through known processes. For example, one or more known systems such as magnetic ferrous separators, eddy current separators, inductive and other electric-current-based sensor based separators, and optical and shape recognition separators may be employed to further separate the ferrous and non-ferrous metals from the heavy fraction. Exemplary techniques are disclosed in U.S. Pat. No. 8,056,730 (“Magnetic Separator for Ferromagnetic Materials with Controlled-Slip Rotating Roller and Relevant Operating Methods”), U.S. Pat. No. 7,732,726 (“System and Method for Sorting Dissimilar Materials Using a Dynamic Sensor”), and U.S. Pat. No. 7,658,291 (“Method and Apparatus for Sorting Fine Nonferrous Metals and Insulated Wire Pieces”). The disclosures of each of these applications are incorporated, in their entirety, by reference.

FIG. 2 depicts a schematic diagram for a separator 150 for ASR landfill materials in accordance with an exemplary embodiment of the present invention. Referring to FIG. 2, the exemplary separator 150 is a “jig” separator. ASR material is delivered to the separator 150 by a conveyor 152. The ASR material moves from the conveyor 152 to a chute 153. The ASR material includes a mix of materials, including light materials 154 and heavy materials 156—although all of the materials originated in the ASR landfill 110. For illustrative purposes, the light material 154 is depicted as white images with a black outline and the heavy material 156 is depicted as black images. Although depicted as uniform in size, the size of each type of particle will vary within a range of sizes.

The separator 150 includes a screen 165 immersed in a tank 160 of liquid (typically water). The liquid level is above the level of the screen 165 (as shown by the line 158). The screen 165 has openings that allow the liquid to move through the screen 165, while the screen 165 supports the excavated and sized ASR material. The separator 150 causes the liquid to pulse up and down through the openings of the screen 165. This pulsating action causes the material, such as the light material 154 and the heavy material 156 to fluidize. As the material moves down the screen 165 (which is slightly angled away from the chute 153) in a direction away from the chute 153, the material particles separate based on their relative densities. The heavier materials settle in layers near the surface of the screen 165 while the lighter materials stratify near the surface of the liquid, above the layers of heavier particles.

The material separator 150 includes a chute 170 and a chute 180. These chutes 170, 180 are positioned such that the heavy material 156 exits the separator 150 at chute 170 and the light material exits the separator 150 at chute 180. Chute 170 includes a rotary valve 175 which allows material to exit the separator 150 but seals the chute 170 such that water does not significantly flow out of the chute. The material that exits the separator 150 at chute 170 is the “heavy fraction” of the excavated ASR material and includes metals, rocks, and glass, including non-ferrous and ferrous metals to be recovered. In one configuration of the separator 150, the angle of the screen 165 can be adjusted to better ensure that the heavy fraction enters chute 170 and the light fraction enters chute 180.

Material that is smaller than the screen size of the screen 165 will fall through the screen 165. This material ultimately settles to the bottom of tank 160 and is removed through opening 185. In an alternative configuration of the separator 150, the chute 170 may be replaced with a configuration where the heavy fraction falls into the tank 160. The heavy fraction is then recovered through opening 185, while the light fraction is removed through chute 180.

Material is continuously fed into the chute 153. The exemplary separator 150 may process more than 100 tons per hour of excavated ASR landfill material.

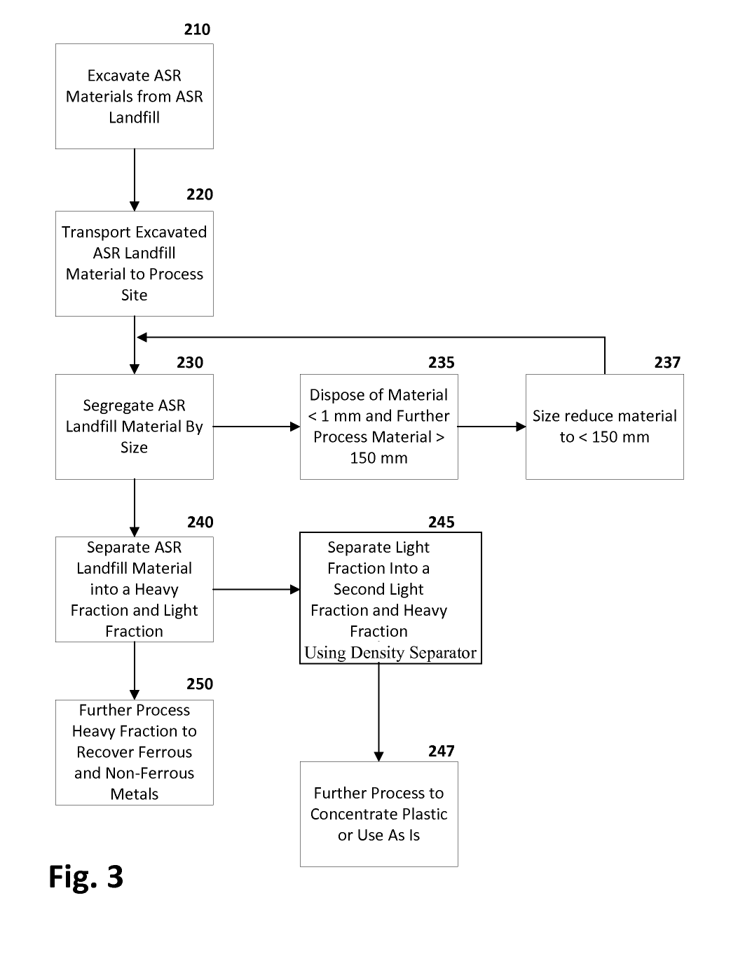

FIG. 3 depicts a process flow diagram for a process 200 for processing material excavated from an ASR landfill to recover recyclable metals in accordance with an exemplary embodiment of the present invention. Referring to FIGS. 1 and 3, at step 210, an excavator 120 excavates ASR and co-mingled material (“ASR material”) from an ASR landfill 110. At step 220, the excavated ASR material is transported by the material transporter 130 to the processing site. The processing site may be co-located with the ASR landfill 110 or remotely located, such that the ASR material is transported by truck or rail (or ship).

At step 230, the excavated ASR material is segregated by size by one or more screens 140. In one embodiment, the ASR material is screened by the one or more screens 140 to provide a feed material for the separator 150 that ranges in size, typically, from 1 mm to 150 mm. Alternatively, the ASR material is segregated into smaller size ranges, such as 1 mm to 5 mm, 5 mm to 20 mm, 20 mm to 50 mm, and 50 mm to 150 mm.

At step 235, material that is less than 1 mm in size as determined at step 230 is disposed of as waste. ASR material that is greater than 150 mm in size is optionally further processed at step 237, such as by size reducing the material to a size of less than 150 mm. One or more known types of equipment, such as crushers, hammer mills, and the like may be used to reduce the size of the material to less than 150 mm in size. Once reduced in size to less than 150 mm, the material is returned to step 230 or introduced into the separator 150 at step 240.

At step 240, the segregated ASR material is separated into a heavy fraction and a light fraction using separator 150. The heavy fraction is further processed at step 250 to recover ferrous and non-ferrous metals through known processes, such as in ferrous and non-ferrous metal recovery subsystem 170. For example, one or more known systems such as magnetic ferrous separators, eddy current separators, inductive and dynamic sensor based separators, and optical and shape recognition separators may be employed to further separate the ferrous and non-ferrous metals from the heavy fraction. Prior to this further processing, the heavy fraction may be dried to reduce its moisture content to less than 15 percent. This drying may be through natural drying or forced drying in the dryer 160.

The light fraction from step 240 is collected and optionally further processed at step 245 by processing the light fraction from step 240 in a second separator similar to the separator 150. To illustrate, the light fraction from step 240 may be further separated based on density to further concentrate the plastic material in the light fraction from step 240. As the light fraction from step 240 has a lower average weight as compared to the material processed at step 240, when using the separator 150, the liquid pulses would be reduced to simulate a liquid density of approximately 1.0 grams per cubic centimeter. In this further processing at step 245, a second heavy and light fraction is generated from the light fraction resulting at step 240. For example, the light fraction from step 245 may represent a material with an approximately 50 percent concentration of plastic material, which, as shown in step 247, could be further concentrated or used commercially as is, such as in making new plastic or as a fuel for an energy plant. Alternatively, at step 245, the light fraction may be disposed of as waste.

One of ordinary skill in the art would appreciate that the present invention provides systems and methods for recovering recyclable metals from an ASR landfill. The systems and methods employ processes that excavate the ASR and co-mingled material from the landfill, size the excavated ASR material, separate the excavated, sized ASR material into a heavy and light fraction, and further process the heavy fraction to recover ferrous and non-ferrous metals.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed is:

1. A method for recovering metal from material excavated from an automobile shredder residue (ASR) landfill, the method comprising the steps of:
excavating a landfill comprising ASR to generate an ASR material, wherein the ASR material comprises a metal material and a plastic material;
screening the ASR material to generate a sized ASR material fraction;
separating the sized ASR material fraction into a heavy fraction and a light fraction, wherein the heavy fraction comprises ferrous and non-ferrous metals; and
processing the heavy fraction to recover the ferrous and non-ferrous metals.

2. The method of claim 1, further comprising the step of transporting the ASR material to a location for separating into the heavy fraction and the light fraction.

3. The method of claim 1, wherein the sized ASR material fraction is sized to a range of 1 mm to 150 mm.

4. The method of claim 1, wherein the sized ASR material fraction is sized into a plurality of size ranges.

5. The method of claim 4, wherein the plurality of size ranges includes the size ranges of 1 mm to 5 mm, 5 mm to 20 mm, 20 mm to 50 mm, and 50 mm to 150 mm.

6. The method of claim 1, wherein the separating step comprises employing a jig separator.

7. The method of claim 1, further comprising the step of drying the heavy fraction of the sized ASR material fraction prior to the step of processing to recover ferrous and non-ferrous metals.

8. The method of claim 1, further comprising the step of separating the light fraction based on density to further concentrate the plastic material in the light fraction.

9. A system for recovering metal from material excavated from an automobile shredder residue (ASR) landfill, the system comprising:
a source of ASR material comprising material excavated from an ASR landfill;
a screen for screening the excavated ASR material to generate a sized ASR material fraction;
a separator for separating the sized ASR material fraction into a heavy fraction and a light fraction; and
a recovery subsystem for processing the heavy fraction to recover ferrous and non-ferrous metals.

10. The system of claim 9, wherein the screen sizes the ASR material fraction to a range of 1 mm to 150 mm.

11. The system of claim 9, wherein the screen comprises a plurality of screens of different mesh sizes.

12. The system of claim 9, wherein the separator comprises a jig separator.

13. The system of claim 9, further comprising a dryer for drying the heavy fraction prior to introducing the heavy fraction into the recovery subsystem.

14. The system of claim 9, further comprising a second separator for separating the light fraction by density to further concentrate the plastic material in the light fraction.
